(19) United States
(12) Patent Application Publication
(10) Pub. No.: US 2021/0113958 A1
(43) Pub. Date: Apr. 22, 2021

(54) AIR CONDITIONER

(71) Applicant: SHARP KABUSHIKI KAISHA, Sakai City, Osaka (JP)

(72) Inventors: JUN SAKUMA, Sakai City, Osaka (JP); TSUYOSHI KAMADA, Sakai City, Osaka (JP); SHO OCHI, Sakai City, Osaka (JP); TETSUYA IDE, Sakai City, Osaka (JP)

(73) Assignees: SHARP KABUSHIKI KAISHA, Sakai City, Osaka (JP); SHARP KABUSHIKI KAISHA, Sakai City, Osaka (JP)

(21) Appl. No.: 17/047,603

(22) PCT Filed: Mar. 26, 2019
(86) PCT No.: PCT/JP2019/012836

§ 371 Date: Oct. 14, 2020

(30) Foreign Application Priority Data
Apr. 16, 2018 (JP) 2018-078268

(51) Int. Cl. B01D 53/26; B01D 53/14; F24F 3/14

(52) U.S. Cl. CPC B01D 53/263; F24F 2003/144; F24F 3/14; B01D 53/1425

(57) ABSTRACT

An air conditioner includes: a moisture absorption unit that brings a liquid hygroscopic material, which contains a hygroscopic substance, and air into contact with each other and thereby causes the liquid hygroscopic material to absorb some moisture contained in the air; an atomizing and regenerating unit that atomizes some moisture contained in the liquid hygroscopic material supplied from the moisture absorption unit, generates atomized droplets, and removes the atomized droplets from the liquid hygroscopic material to thereby regenerate the liquid hygroscopic material and supply the regenerated liquid hygroscopic material to the moisture absorption unit; a circulation flow path through which air containing the atomized droplets is discharged from the atomizing and regenerating unit and the air is returned to the atomizing and regenerating unit; and an atomized droplet collecting unit that is provided in the circulation flow path and that collects the atomized droplets from the air.

### TECHNICAL FIELD

The present invention relates to an air conditioner.

This application claims priority based on Japanese Patent Application No. 2018-078268 filed in Japan on Apr. 16, 2018, the content of which is incorporated herein.

### BACKGROUND ART

Air conditioners which control humidity or temperature in a room are conventionally known.

For example, PTL 1 described below discloses a “dehumidifier provided with a function for regenerating a dehumidifying agent” in which the air is dehumidified by a dehumidifying action of a deliquescent dehumidifying agent housed in a main body vessel and the dehumidifying agent is regenerated by heating deliquescent liquid of the dehumidifying agent deliquesced by the dehumidifying action. The dehumidifier is repeatedly used and thus has a function for regenerating the dehumidifying agent by causing moisture from the air to be absorbed by the dehumidifying agent and then causing the absorbed moisture to be desorbed from the dehumidifying agent.

### CITATION LIST

### Patent Literature

PTL 1: Japanese Unexamined Patent Application Publication No. 2001-149737

### SUMMARY OF INVENTION

### Technical Problem

In conventional dehumidifying devices including the dehumidifier of PTL 1, regeneration of a dehumidifying agent is accompanied by a phase change from moisture (liquid) to vapor (gas) such that the dehumidifying agent is heated and the moisture is vaporized and desorbed. Therefore, there is a problem that such a dehumidifying device needs energy which is equal to or more than the latent heat of water and requires much power to be consumed in regenerating the dehumidifying agent. The problem is not a problem limited to dehumidifying devices but is a general problem for air conditioners capable of controlling both humidity and temperature.

An aspect of the invention is to solve the aforementioned problem, and an object thereof is to provide an air conditioner capable of reducing power consumption required for regeneration of a moisture absorbent.

### Solution to Problem

To accomplish the aforementioned object, an air conditioner of an aspect of the invention includes: a moisture absorption unit that brings a liquid hygroscopic material, which contains a hygroscopic substance, and air into contact with each other and thereby causes the liquid hygroscopic material to absorb at least some moisture contained in the air; an atomizing and regenerating unit that atomizes at least some moisture contained in the liquid hygroscopic material supplied from the moisture absorption unit, generates atomized droplets, and removes at least some of the atomized droplets from the liquid hygroscopic material to thereby regenerate the liquid hygroscopic material and supply the regenerated liquid hygroscopic material to the moisture absorption unit; a circulation flow path through which air containing the atomized droplets generated in the atomizing and regenerating unit is discharged from the atomizing and regenerating unit and the air from which at least some of the atomized droplets are removed is returned to the atomizing and regenerating unit; and an atomized droplet collecting unit that is provided in the circulation flow path and that collects at least some of the atomized droplets from the air containing the atomized droplets.

The air conditioner of an aspect of the invention may further include a droplet separating unit that is provided in the circulation flow path and that separates first droplets which are included in the atomized droplets and have a relatively small diameter and second droplets which are included in the atomized droplets and have a relatively large diameter.

The air conditioner of an aspect of the invention may further include a reflux flow path through which the second droplets separated by the droplet separating unit are returned to the atomizing and regenerating unit.

In the air conditioner of an aspect of the invention, the atomizing and regenerating unit may include at least a first atomizing tank connected to the moisture absorption unit and a second atomizing tank connected to the first atomizing tank, the reflux flow path may be a flow path through which the second droplets are returned to the first atomizing tank, and the circulation flow path may be a flow path via which the droplet separating unit, the atomized droplet collecting unit, the first atomizing tank, and the second atomizing tank communicate in series.

In the air conditioner of an aspect of the invention, the atomizing and regenerating unit may include at least a first atomizing tank connected to the moisture absorption unit and a second atomizing tank connected to the first atomizing tank, the reflux flow path may be a flow path through which the second droplets are returned to the first atomizing tank, and the circulation flow path may include at least a first circulation flow path via which the droplet separating unit, the atomized droplet collecting unit, and the first atomizing tank communicate and a second circulation flow path via which the droplet separating unit, the atomized droplet collecting unit, and the second atomizing tank communicate.

The air conditioner of an aspect of the invention may further include a cooling unit that is provided in the atomized droplet collecting unit and that cools the air which is supplied to the atomized droplet collecting unit and which contains the atomized droplets.

The air conditioner of an aspect of the invention may further include a heating unit that is provided in the circulation flow path and that heats the air which flows in the circulation flow path and from which at least some of the atomized droplets are removed.

### Advantageous Effects of Invention

According to an aspect of the invention, an air conditioner capable of reducing power consumption required for regeneration of a liquid hygroscopic material is provided.

### BRIEF DESCRIPTION OF DRAWINGS

FIG. 1 illustrates a schematic configuration of an air conditioner of a first embodiment.

FIG. 2 illustrates a schematic configuration of an air conditioner of a second embodiment.

FIG. 3 illustrates a schematic configuration of an air conditioner of a third embodiment.

FIG. 4 illustrates a schematic configuration of an air conditioner of a fourth embodiment.

FIG. 5 illustrates a schematic configuration of an air conditioner of a fifth embodiment.

### DESCRIPTION OF EMBODIMENTS

### First Embodiment

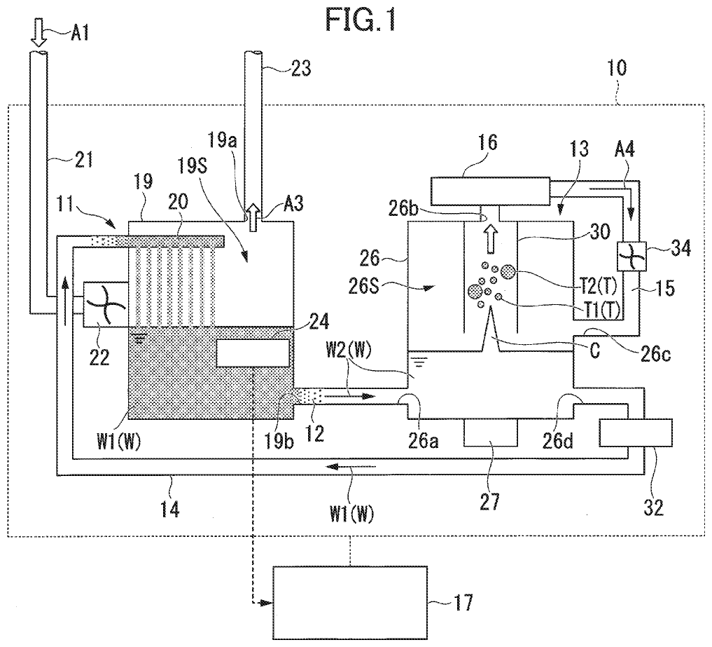

A first embodiment of the invention will be described below with reference to FIG. 1.

FIG. 1 illustrates a schematic configuration of an air conditioner of the first embodiment.

Note that, in the drawings below, constituent elements may be illustrated at different dimensional scales for clarity of each of the constituent elements.

An air conditioner 10 of the present embodiment includes at least a humidity control function of lowering humidity in a room where the air conditioner 10 is installed and thereby controlling the humidity within an appropriate range. The air conditioner 10 may further include a temperature control function in addition to the humidity control function or may not include the temperature control function.

As illustrated in FIG. 1, the air conditioner 10 of the present embodiment includes a moisture absorption unit 11, a first liquid hygroscopic material transport pipe 12, an atomizing and regenerating unit 13, a second liquid hygroscopic material transport pipe 14, a circulation pipe 15 (circulation flow path), an atomized droplet collecting unit 16, and a control unit 17. Note that the moisture absorption unit 11, the atomizing and regenerating unit 13, and the control unit 17 may be accommodated in one housing or may be separately arranged.

The moisture absorption unit 11 brings, inside thereof, a liquid hygroscopic material, which contains a hygroscopic substance, and the air into contact with each other and causes the liquid hygroscopic material to absorb at least some moisture contained in the air. Through the first liquid hygroscopic material transport pipe 12, the liquid hygroscopic material containing the hygroscopic substance is transported from the moisture absorption unit 11 to the atomizing and regenerating unit 13. The atomizing and regenerating unit 13 atomizes at least some moisture contained in the liquid hygroscopic material supplied from the moisture absorption unit 11 via the first liquid hygroscopic material transport pipe 12, generates atomized droplets, and removes at least some of the atomized droplets from the liquid hygroscopic material to thereby regenerate the liquid hygroscopic material and supply the regenerated liquid hygroscopic material to the moisture absorption unit 11. Through the second liquid hygroscopic material transport pipe 14, the regenerated liquid hygroscopic material is transported from the atomizing and regenerating unit 13 to the moisture absorption unit 11.

Through the circulation pipe 15, the air containing the atomized droplets generated in the atomizing and regenerating unit 13 is discharged from the atomizing and regenerating unit 13 and the air from which at least some of the atomized droplets are removed is returned to the atomizing and regenerating unit 13 again. The atomized droplet collecting unit 16 is provided in the middle of the circulation pipe 15 and collects at least some of the atomized droplets from the air containing the atomized droplets. The control unit 17 controls the respective units, including the moisture absorption unit 11 and the atomizing and regenerating unit 13, of the air conditioner 10.

The moisture absorption unit 11 includes a moisture absorption tank 19, a nozzle part 20, a first air supply pipe 21, a blower 22, an air discharge pipe 23, and a measuring unit 24.

The moisture absorption tank 19 is a container for storing a liquid hygroscopic material W that absorbs moisture from the air. The moisture absorption tank 19 is provided with a first discharge port 19a and a first liquid hygroscopic material discharge port 19b. Moreover, the first air supply pipe 21, the air discharge pipe 23, the first liquid hygroscopic material transport pipe 12, and the second liquid hygroscopic material transport pipe 14 are connected to the moisture absorption tank 19. A tip end of the second liquid hygroscopic material transport pipe 14 is inserted into an inner space 19S of the moisture absorption tank 19, and the nozzle part 20 is provided in a portion of the tip end, which is inserted into the inner space 19S.

The liquid hygroscopic material W is a liquid that exhibits moisture hygroscopicity and is preferably a liquid that exhibits hygroscopicity at a temperature of 25° C. and a relative humidity of 50% and under atmospheric conditions.

The liquid hygroscopic material W contains a hygroscopic substance. That is, the liquid hygroscopic material W may contain a hygroscopic substance and a solvent. As an appropriate solvent, a solvent that has a property of dissolving the hygroscopic substance or a property of being mixable with the hygroscopic substance is used, and an example thereof includes water. The hygroscopic substance may be an organic material described below or an inorganic material.

Examples of the organic material used as the hygroscopic substance include a dihydric or higher alcohol, a ketone, an organic solvent having an amide group, a saccharide, and a known material used as a raw material for moisturizing cosmetics etc. Among these, from the viewpoint of high hydrophilicity, the dihydric or higher alcohol, the organic solvent having the amide group, the saccharide, or the known material used as the raw material for moisturizing cosmetics etc. is preferable as the organic material used as the hygroscopic substance.

As the dihydric or higher alcohol, for example, glycerin, propanediol, butanediol, pentanediol, trimethylolpropane, butanetriol, ethylene glycol, diethylene glycol, or triethylene glycol is used.

As the organic solvent having the amide group, for example, formamide or acetamide is used.

As the saccharide, for example, sucrose, pullulan, glucose, xylol, fructose, mannitol, or sorbitol is used.

As the known material used as the raw material for moisturizing cosmetics etc., for example, 2-methacryloyloxyethyl phosphorylcholine (MPC), betaine, hyaluronic acid, or collagen is used.

As the inorganic material used as the hygroscopic substance, for example, calcium chloride, lithium chloride, magnesium chloride, potassium chloride, sodium chloride, zinc chloride, aluminum chloride, lithium bromide, calcium bromide, potassium bromide, sodium hydroxide, or sodium pyrrolidone carboxylate is used.

In a case where hydrophilicity of the hygroscopic substance is high, when, for example, the hygroscopic substance is mixed with water, a high proportion of water molecules exists in the vicinity of a surface (liquid surface) of the liquid hygroscopic material W. The atomizing and regenerating unit 13 described later generates atomized droplets in the vicinity of the surface of the liquid hygroscopic material W to thereby separate moisture from the liquid hygroscopic material W. Thus, when the proportion of the water molecules in the vicinity of the surface of the liquid hygroscopic material W is high, the moisture is able to be efficiently separated. Moreover, when the hydrophilicity of the hygroscopic substance is high, a relatively low proportion of the hygroscopic substance exists in the vicinity of the surface of the liquid hygroscopic material W. Therefore, it is possible to reduce loss of the hygroscopic substance in the atomizing and regenerating unit 13.

In the liquid hygroscopic material W, a concentration of the hygroscopic substance of a liquid hygroscopic material W1 which is used for moisture absorption treatment in the moisture absorption unit 11 is not particularly limited, but is preferably 40 mass % or more. When the concentration is 40 mass % or more, the liquid hygroscopic material W1 is able to efficiently absorb moisture. Note that the liquid hygroscopic material W in the moisture absorption unit 11 may also be referred to as the liquid hygroscopic material W1.

Viscosity of the liquid hygroscopic material W is preferably 25 mPa·s or less. Thereby, a liquid column C of a liquid hygroscopic material W2 is easily generated in a liquid surface of the liquid hygroscopic material W2 in the atomizing and regenerating unit 13. Thus, moisture is able to be efficiently separated from the liquid hygroscopic material W2. Note that the liquid hygroscopic material W which has absorbed moisture in the first liquid hygroscopic material transport pipe 12 or in the atomizing and regenerating unit 13 may also be referred to as the liquid hygroscopic material W2.

The inner space 19S of the moisture absorption tank 19 and an outer space communicate with each other via the first air supply pipe 21. One end of the first air supply pipe 21 is exposed to the outer space, and the other end of the first air supply pipe 21 is connected to the blower 22. Thereby, air A1 in the outer space of the moisture absorption tank 19 is supplied by the blower 22 to the inner space 19S via the first air supply pipe 21. While forming an air current that flows toward the first discharge port 19a of the moisture absorption tank 19 from the blower 22, the air A1 supplied to the inner space 19S comes into contact with the liquid hygroscopic material W1. Thereby, in the inner space, a humidity control unit is able to bring the air A1 and the liquid hygroscopic material W1 into contact with each other and cause the liquid hygroscopic material W1 to absorb moisture contained in the air A1.

The nozzle part 20 has a plurality of openings and causes the liquid hygroscopic material W1 to flow downward from the plurality of openings in the inner space 19S of the moisture absorption tank 19. The nozzle part 20 is provided in an upper portion of the inner space 19S of the moisture absorption tank 19 and is connected to the second liquid hygroscopic material transport pipe 14. As described above, since the air current of the air A1 is generated in the inner space 19S of the moisture absorption tank 19, the air current of the air A1 and the liquid hygroscopic material W1 flowing down from the nozzle part 20 are brought into contact with each other. Such a system for supplying the liquid hygroscopic material W1 is typically called a flow-down system. Note that the system for supplying the liquid hygroscopic material W1 is not necessarily limited to a flow-down system.

The inner space 19S of the moisture absorption tank 19 and the outer space communicate with each other via the air discharge pipe 23. One end of the air discharge pipe 23 is exposed to the outer space, and the other end of the air discharge pipe 23 is connected to the first discharge port 19a. Thereby, air A3, the moisture of which has been absorbed by the liquid hygroscopic material W1 in the moisture absorption tank 19, is discharged to the outer space from the first discharge port 19a via the air discharge pipe 23. Thus, the air A3, the humidity of which is lowered compared to that of the air A1 which is introduced into the moisture absorption tank 19 via the first air supply pipe 21, is discharged via the air discharge pipe 23 into the room where the one end of the air discharge pipe 23 is arranged. In this manner, the air conditioner 10 of the present embodiment is able to lower humidity in the room.

The measuring unit 24 measures the concentration of the hygroscopic substance contained in the liquid hygroscopic material W1. A measurement result of the concentration, which is obtained by the measuring unit 24, is output to the control unit 17. The control unit 17 controls the concentration of the hygroscopic substance in the liquid hygroscopic material W1 to fall within a range of a desired concentration on the basis of the measurement result obtained by the measuring unit 24. In this case, “range of desired concentration” means a range of the concentration which is suitable for the liquid hygroscopic material to absorb moisture and is, for example, 40 mass % or more.

The control unit 17 controls at least one of an ultrasonic vibrator 27, a pump, a blower 29, and a blower which will be described below and performs control such that the concentration of the hygroscopic substance reaches the desired concentration.

The first liquid hygroscopic material transport pipe 12 is connected between a liquid hygroscopic material supply port in a lower portion of an atomizing and regenerating tank described later and the first liquid hygroscopic material discharge port 19b in a lower portion of the moisture absorption tank 19, and an inner space of the atomizing and regenerating tank and the inner space 19S of the moisture absorption tank 19 communicate with each other via the first liquid hygroscopic material transport pipe 12. Through the first liquid hygroscopic material transport pipe 12, the liquid hygroscopic material W2 which has absorbed the moisture in the moisture absorption tank 19 is transported to the atomizing and regenerating tank described later.

The atomizing and regenerating unit 13 includes the atomizing and regenerating tank 26, the ultrasonic vibrator 27, and a guide pipe 30.

The atomizing and regenerating tank 26 is a container for storing the liquid hygroscopic material W2 which has absorbed the moisture. The atomizing and regenerating tank 26 is provided with the liquid hygroscopic material supply port 26a, a second discharge port 26b, an air supply port 26c, and a second liquid hygroscopic material discharge port 26d. Moreover, the circulation pipe 15 and the second liquid hygroscopic material transport pipe 14 are connected to the atomizing and regenerating tank 26.

The ultrasonic vibrator 27 is provided in a bottom portion of the atomizing and regenerating tank 26. The ultrasonic vibrator 27 irradiates the liquid hygroscopic material W2 stored in the atomizing and regenerating tank 26 with ultrasonic waves and generates atomized droplets T, which contain moisture, from the liquid hygroscopic material W2. By appropriately setting a driving condition of the ultrasonic vibrator 27 when the ultrasonic vibrator 27 irradiates the liquid hygroscopic material W2 with ultrasonic waves, it is possible to generate the liquid column C of the liquid hygroscopic material W2 in the liquid surface of the liquid hygroscopic material W2. Many atomized droplets T containing moisture are generated from the liquid column C of the liquid hygroscopic material W2. Note that atomized droplets T include fine droplets T1 and coarse droplets T2 which will be described in a second embodiment.

The guide pipe 30 is provided at a position facing the ultrasonic vibrator 27 so as to surround the second discharge port 26b and extend downward from a top surface of the atomizing and regenerating tank 26. In the atomizing and regenerating unit 13, since the second discharge port 26b is at the position facing the ultrasonic vibrator 27, the liquid column C of the liquid hygroscopic material W2 is generated below the second discharge port 26b. Thus, the liquid column C is generated at a position surrounded by the guide pipe 30. Since the second discharge port 26b, the guide pipe 30, and the liquid column C have such a positional relationship, an air current which flows from the liquid surface of the liquid hygroscopic material W2 to an upper side in the guide pipe 30 transports, to the second discharge port 26b, the atomized droplets T generated from the liquid column C of the liquid hygroscopic material W2.

In this manner, air A4 containing the atomized droplets T is discharged from the second discharge port 26b to an outer space of the atomizing and regenerating tank 26. Thereby, it is possible to separate the moisture from the liquid hygroscopic material W2 and regenerate the liquid hygroscopic material W2. Note that the air A4 discharged from the second discharge port 26b contains the atomized droplets T generated in the atomizing and regenerating tank 26 and is therefore in a state where humidity thereof is higher than that of the air A1 in the outer space.

The second liquid hygroscopic material transport pipe 14 is connected between the second liquid hygroscopic material discharge port 26d in a lower portion of the atomizing and regenerating tank 26 and the nozzle part 20 in an upper portion of the moisture absorption tank 19. Through the second liquid hygroscopic material transport pipe 14, the liquid hygroscopic material W1 which is regenerated after having the moisture separated in the atomizing and regenerating tank 26 is transported to the moisture absorption tank 19. In the middle of the second liquid hygroscopic material transport pipe 14, a pump 32 by which the liquid hygroscopic material W1 is transported from the atomizing and regenerating tank 26 to the moisture absorption tank 19 is provided.

The circulation pipe 15 is connected between the second discharge port 26b and the air supply port 26c of the atomizing and regenerating tank 26. Through the circulation pipe 15, the air which contains the atomized droplets T generated in the atomizing and regenerating unit 13 is discharged from the atomizing and regenerating tank 26, and the air from which at least some of the atomized droplets T are removed is returned to the atomizing and regenerating unit 13. That is, an inside of the circulation pipe 15 is a flow path through which the air flows, and the circulation pipe 15 corresponds to a circulation flow path of the claims. A blower 34 by which the air is circulated is provided in the middle of the circulation pipe 15.

The atomized droplet collecting unit 16 is provided in the middle of the circulation pipe 15. The atomized droplet collecting unit 16 collects at least some of the atomized droplets T from the air containing the atomized droplets T. A known separation device capable of separating the atomized droplets T from the air is used for the atomized droplet collecting unit 16. As the separation device of this kind, for example, a gas-liquid coalescer is used. Moreover, the atomized droplet collecting unit 16 includes a drain through which water formed by aggregation of separated atomized droplets is taken out.

According to the air conditioner 10 of the present embodiment, in the atomizing and regenerating tank 26, ultrasonic waves are applied to the liquid hygroscopic material W2, which has absorbed the moisture, to thereby generates the atomized droplets T, the moisture contained in the atomized droplets T is separated from the liquid hygroscopic material W2, and thus the liquid hygroscopic material W2 is regenerated. Therefore, the air conditioner 10 of the present embodiment does not cause a phase change of moisture from liquid to gas, which is used in a conventional regenerating method. Thereby, it is possible to achieve the air conditioner capable of reducing power consumption required for regeneration of the liquid hygroscopic material W2.

Moreover, the atomized droplets T generated in the atomizing and regenerating tank 26 contain a minute amount of hygroscopic substance, such as glycerin, with moisture. Thus, when a configuration is assumed to be such that the air A4 containing the atomized droplets T provided in the atomizing and regenerating tank 26 is discharged to the outer space of the atomizing and regenerating tank 26, the hygroscopic substance such as glycerin is emitted to the outer space, and an environmental load may be caused. In addition, since the air A4 containing the atomized droplets T, in other words, the air having high humidity is to be emitted to the outer space of the atomizing and regenerating tank 26, a humidity lowering effect which is obtained by using the dry air A3 discharged from the moisture absorption unit 11 may not be sufficiently exerted.

On the other hand, the air conditioner 10 of the present embodiment has a configuration in which the air A4 containing the atomized droplets T is discharged to the circulation pipe 15 and is returned again to the atomizing and regenerating tank 26 through the circulation pipe 15 after at least some of the atomized droplets T are collected in the atomized droplet collecting unit 16. That is, in the air conditioner 10 of the present embodiment, the air A4 containing the atomized droplets T is not discharged to the outer space of the atomizing and regenerating tank 26. Thus, it is possible to eliminate a possibility, for example, that the environmental load is caused by the emission of the hygroscopic substance to the outer space or that the humidity lowering effect obtained by using the moisture absorption unit 11 is not sufficiently exerted due to the discharge of the highly humid air.

### Second Embodiment

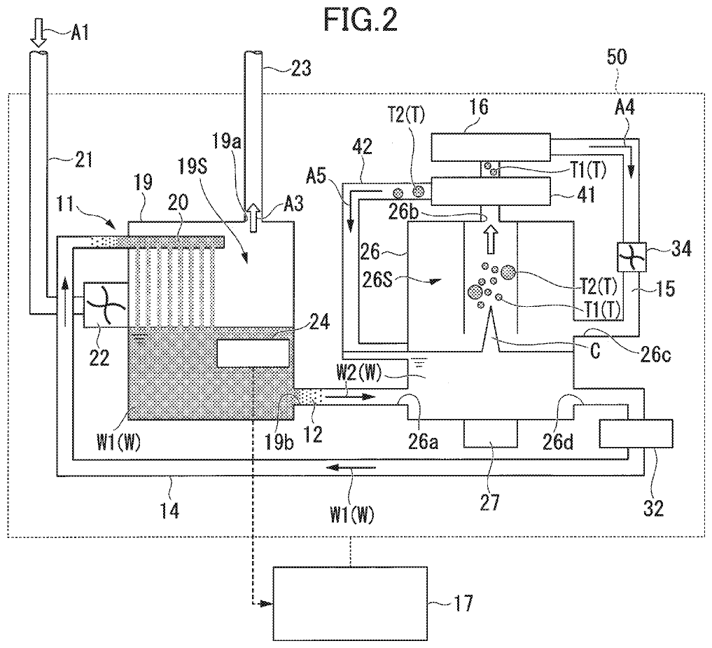

An air conditioner of the second embodiment will be described below with reference to FIG. 2.

A basic configuration of the air conditioner of the second embodiment is the same as that of the first embodiment, but a configuration of an atomizing and regenerating unit is different from that of the first embodiment.

FIG. 2 illustrates a schematic configuration of the air conditioner of the second embodiment.

In FIG. 2, constituent elements common to the first embodiment in FIG. 1 will be given the same reference signs, and detailed description thereof will be omitted.

As illustrated in FIG. 2, an air conditioner 50 of the present embodiment includes the moisture absorption unit 11, the first liquid hygroscopic material transport pipe 12, the atomizing and regenerating unit 13, the second liquid hygroscopic material transport pipe 14, the circulation pipe 15 (circulation flow path), a droplet separating unit 41, a reflux pipe 42 (reflux flow path), the atomized droplet collecting unit 16, and the control unit 17. That is, the air conditioner 50 of the present embodiment further includes the droplet separating unit 41 and the reflux pipe 42 in addition to the configuration of the air conditioner 10 of the first embodiment.

Although description is omitted in the first embodiment, the inventors found that the atomized droplets T generated from the liquid hygroscopic material W2 include the fine droplets T1 (first droplets) which have a diameter approximately less than 1 μm and which are relatively small and the coarse droplets T2 (second droplets) which have a diameter of 1 μm or more and which are relatively large.

The inventors also found that one droplet contains moisture and the hygroscopic substance and, when a proportion of weight of the moisture to weight of one droplet is defined as a rate of moisture content, a diameter of the droplet and the rate of moisture content have a correlation, and the smaller the diameter of the droplet is, the higher the rate of moisture content is. Thus, in a case of the present embodiment, a rate of moisture content of the fine droplets T1 is higher than a rate of moisture content of the coarse droplets T2. Conversely, a rate of content of the hygroscopic substance of the coarse droplets T2 is higher than a rate of content of the hygroscopic substance of the fine droplets T1.

In the case of the present embodiment, the droplet separating unit 41 is provided in the middle of the circulation pipe 15 and is arranged between the second discharge port 26b and the atomized droplet collecting unit 16. The droplet separating unit 41 separates the fine droplets T1 which are included in the atomized droplets T and which have the relatively small diameter and the coarse droplets T2 which are included in the atomized droplets T and which have the relatively large diameter. It is sufficient that the droplet separating unit 41 is able to separate and collect the fine droplets T1 and the coarse droplets T2, and a specific form of the separation device is not particularly limited. For example, a known mist separator or a known membrane module having a gas permeable membrane is used as the droplet separating unit 41. Moreover, a cyclone separator, a mesh-type mist separator called a demister, or a wave-plate mist separator called a chevron is used as the known mist separator.

The reflux pipe 42 is provided between the droplet separating unit 41 and the atomizing and regenerating tank 26 and has one end connected to the droplet separating unit 41 and has the other end connected to the atomizing and regenerating tank 26. Of the fine droplets T1 and the coarse droplets T2 that are separated from each other by the droplet separating unit 41, mainly the coarse droplets T2 are returned to the atomizing and regenerating tank 26 through the reflux pipe 42, while being carried by a flow of air A5. However, there is not necessarily the flow of the air A5 in the reflux pipe 42. In this case, it is sufficient that a configuration is such that the droplets are aggregated to form large droplets in the droplet separating unit 41 and the large droplets flow inside the reflux pipe 42 due to gravity.

The other points of the configuration of the air conditioner 50 are similar to those of the first embodiment.

Similarly to the first embodiment, the air conditioner 50 of the present embodiment is also able to provide an effect that the air conditioner capable of reducing power consumption required for regeneration of the liquid hygroscopic material W is able to be achieved. Moreover, similarly to the first embodiment, it is possible to provide an effect that a possibility that the environmental load is caused or a possibility that the humidity lowering effect is not sufficiently exerted is able to be eliminated.

In addition, an effect specific to the present embodiment is as follows.

Since the air conditioner 50 includes the droplet separating unit 41 and the reflux pipe 42, and the coarse droplets T2 whose rate of content of the hygroscopic substance is high are separated by the droplet separating unit 41, the number of coarse droplets T2 which flow into the atomized droplet collecting unit 16 at a post-stage is reduced. Thereby, it is possible to reduce an amount of the hygroscopic substance that leaks out with the water which is taken out by using the drain of the atomized droplet collecting unit 16. Moreover, since the coarse droplets T2 which are separated by the droplet separating unit 41 are returned to the atomizing and regenerating tank 26 via the reflux pipe 42, it is possible to improve recyclability of the hygroscopic substance.

Note that, although the air conditioner 50 includes the reflux pipe 42 in the present embodiment, when the effect of improving the recyclability of the hygroscopic substance is not required, the reflux pipe 42 may not be included, and a configuration may be such that the coarse droplets T2 are discharged from the droplet separating unit 41.

### Third Embodiment

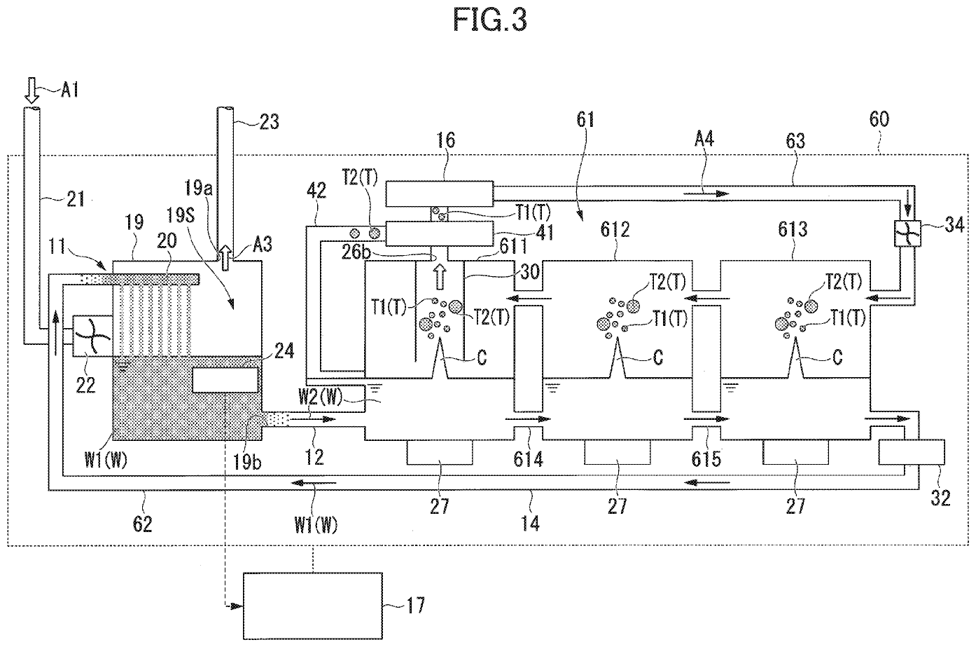

An air conditioner of a third embodiment will be described below with reference to FIG. 3.

A basic configuration of the air conditioner of the third embodiment is the same as that of the first embodiment, but a configuration of an atomizing and regenerating unit is different from that of the first embodiment.

FIG. 3 illustrates a schematic configuration of the air conditioner of the third embodiment.

In FIG. 3, constituent elements common to FIGS. 1 and 2 will be given the same reference signs, and detailed description thereof will be omitted.

As illustrated in FIG. 3, an air conditioner 60 of the present embodiment includes the moisture absorption unit 11, the first liquid hygroscopic material transport pipe 12, an atomizing and regenerating unit 61, a second liquid hygroscopic material transport pipe 62, a circulation pipe 63 (circulation flow path), the droplet separating unit 41, the reflux pipe 42 (reflux flow path), the atomized droplet collecting unit 16, and the control unit 17. In the air conditioner 60 of the present embodiment, a configuration of the atomizing and regenerating unit 61 is different from a configuration of the atomizing and regenerating unit 13 of the first embodiment.

The atomizing and regenerating unit 61 of the present embodiment includes a first atomizing tank 611, a second atomizing tank 612, a third atomizing tank 613, a third liquid hygroscopic material transport pipe 614, and a fourth liquid hygroscopic material transport pipe 615. The first atomizing tank 611 is connected to the moisture absorption tank 19 via the first liquid hygroscopic material transport pipe 12. The second atomizing tank 612 is connected to the first atomizing tank 611 via the third liquid hygroscopic material transport pipe 614. The third atomizing tank 613 is connected to the second atomizing tank 612 via the fourth liquid hygroscopic material transport pipe 615. Note that the number of atomizing tanks which constitute the atomizing and regenerating unit 61 is not limited to three and is able to be changed as appropriate, and it is sufficient that the atomizing and regenerating unit 61 includes at least the first atomizing tank 611 and the second atomizing tank 612.

In this manner, the first atomizing tank 611 and the second atomizing tank 612 communicate with each other via the third liquid hygroscopic material transport pipe 614, and the second atomizing tank 612 and the third atomizing tank 613 communicate with each other via the fourth liquid hygroscopic material transport pipe 615. Furthermore, the moisture absorption tank 19 and the first atomizing tank 611 communicate with each other via the first liquid hygroscopic material transport pipe 12. Thus, the liquid hygroscopic material W2 discharged from the moisture absorption tank 19 is circulated by operation of the pump 32 in the first atomizing tank 611, the second atomizing tank 612, the third atomizing tank 613, and the moisture absorption tank 19 in this order.

A configuration of the first atomizing tank 611 of the present embodiment is similar to the configuration of the atomizing and regenerating tank 26 of the first embodiment, except that the first atomizing tank 611 is connected to the second atomizing tank 612 via the third liquid hygroscopic material transport pipe 614 and a circulation pipe 63 described later. Moreover, each of the second atomizing tank 612 and the third atomizing tank 613 includes the ultrasonic vibrator 27 similarly to the first atomizing tank 611. Thus, the liquid column C of the liquid hygroscopic material W2 is generated in each of the second atomizing tank 612 and the third atomizing tank 613 in accordance with operation of the ultrasonic vibrator 27, and the atomized droplets T including the fine droplets T1 and the coarse droplets T2 are generated.

The reflux pipe 42 is provided between the droplet separating unit 41 and the first atomizing tank 611 and has one end connected to the droplet separating unit 41 and has the other end connected to the first atomizing tank 611. The coarse droplets T2 separated from the fine droplets T1 by the droplet separating unit 41 are returned to the atomizing and regenerating tank 26 through the reflux pipe 42, while being carried by the flow of the air A5. Similarly to the second embodiment, there is not necessarily the flow of the air A5 in the reflux pipe 42 in the present embodiment, either. In this case, it is sufficient that a configuration is such that the droplets are aggregated to form large droplets in the droplet separating unit 41 and the large droplets flow inside the reflux pipe 42 due to gravity.

The circulation pipe 63 is provided so as to lie between the first atomizing tank 611 and the droplet separating unit 41, between the droplet separating unit 41 and the atomized droplet collecting unit 16, between the atomized droplet collecting unit 16 and the third atomizing tank 613, between the third atomizing tank 613 and the second atomizing tank 612, and between the second atomizing tank 612 and the first atomizing tank 611. With this configuration, the first atomizing tank 611, the droplet separating unit 41, the atomized droplet collecting unit 16, the third atomizing tank 613, and the second atomizing tank 612 communicate via the circulation pipe 63 in series.

The air discharged from the first atomizing tank 611 is circulated by operation of the blower 34 in the droplet separating unit 41, the atomized droplet collecting unit 16, the third atomizing tank 613, the second atomizing tank 612, and the first atomizing tank 611 in this order. The atomized droplets T generated in each of the second atomizing tank 612 and the third atomizing tank 613 are caused to flow into the first atomizing tank 611 by the above-described air current and are then discharged toward the droplet separating unit 41.

The other points of the configuration of the air conditioner 60 are similar to those of the first embodiment and the second embodiment. Note that, although the air conditioner 60 of the present embodiment includes the droplet separating unit 41, the droplet separating unit 41 may not be included similarly to the air conditioner 10 of the first embodiment.

Similarly to the first embodiment, the air conditioner 60 of the present embodiment is also able to provide an effect that the air conditioner capable of reducing power consumption required for regeneration of the liquid hygroscopic material W is able to be achieved. Moreover, similarly to the first embodiment, it is possible to provide an effect that a possibility that the environmental load is caused or a possibility that the humidity lowering effect is not sufficiently exerted is able to be eliminated.

In addition, an effect specific to the air conditioner 60 of the present embodiment is as follows.

Since the atomizing and regenerating unit 61 includes three atomizing tanks of the first atomizing tank 611, the second atomizing tank 612, and the third atomizing tank 613, for example, as compared with the atomizing and regenerating unit 13 of the first embodiment, which includes one atomizing tank, when the entire atomization amount is the same between the atomizing and regenerating unit 61 of the present embodiment and the atomizing and regenerating unit 13 of the first embodiment, the atomizing and regenerating unit 61 needs less atomization amount per atomizing tank, and it is possible to reduce load of each of the atomizing tanks.

Moreover, in the atomizing and regenerating unit 61, the liquid hygroscopic material W2 from which some of the moisture is removed in the first atomizing tank 611 is supplied to the second atomizing tank 612, and the liquid hygroscopic material W2 from which some of the moisture is further removed in the second atomizing tank 612 is supplied to the third atomizing tank 613. Thus, a concentration of the hygroscopic substance in the liquid hygroscopic material W2 is high in order of the first atomizing tank 611, the second atomizing tank 612, and the third atomizing tank 613. Although the coarse droplets T2 are separated from the fine droplets T1 by the droplet separating unit 41, the hygroscopic substance and the moisture are not completely separated, and the coarse droplets T2 also contains the moisture.

Therefore, when a configuration is assumed to be such that the reflux pipe 42 is connected to the third atomizing tank 613 and the coarse droplets T2 are returned to the third atomizing tank 613, a problem that the concentration of the hygroscopic substance of the liquid hygroscopic material W1 which is returned to the moisture absorption tank 19 from the third atomizing tank 613 is lowered and absorbing performance in the moisture absorption tank 19 is degraded is caused. On the other hand, since the atomizing and regenerating unit 61 of the present embodiment is configured such that the reflux pipe 42 is connected to the first atomizing tank 611 and the coarse droplets T2 are returned to the first atomizing tank 611 in which the concentration of the hygroscopic substance is the lowest among the three atomizing tanks, it is possible to return the liquid hygroscopic material in the third atomizing tank 613, in which the concentration of the hygroscopic substance is the highest, to the moisture absorption tank 19 as it is. It is thereby possible to keep the absorbing performance in the moisture absorption tank 19 without causing the above-described problem.

Moreover, since the configuration is such that the air discharged from the first atomizing tank 611 is circulated in the droplet separating unit 41, the atomized droplet collecting unit 16, the third atomizing tank 613, the second atomizing tank 612, and the first atomizing tank 611 in this order through the circulation pipe 63, the atomized droplets T from the air discharged from the first atomizing tank 611 do not flow into the second atomizing tank 612 or the third atomizing tank 613. It is thereby possible to keep the concentration of the hygroscopic substance in each of the second atomizing tank 612 and the third atomizing tank 613.

However, when the concentration of the hygroscopic substance in each of the second atomizing tank 612 and the third atomizing tank 613 is lowered within an allowable range, contrary to the above configuration, a configuration may be such that the air discharged from the first atomizing tank 611 is circulated in the second atomizing tank 612, the third atomizing tank 613, the atomized droplet collecting unit 16, the droplet separating unit 41, and the first atomizing tank 611 in this order.

### Fourth Embodiment

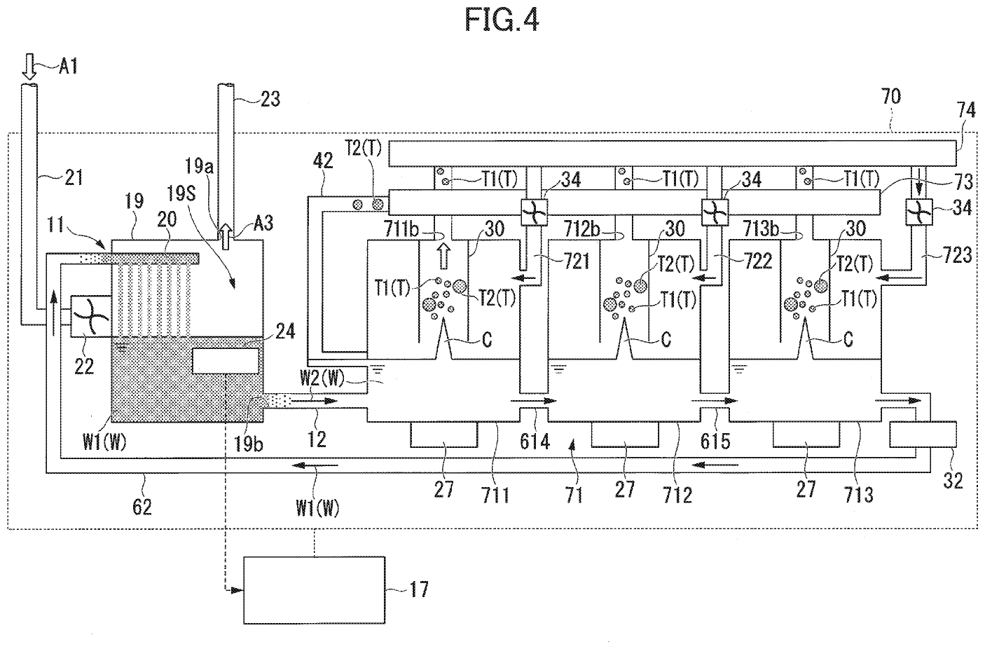

An air conditioner of a fourth embodiment will be described below with reference to FIG. 4.

A basic configuration of the air conditioner of the fourth embodiment is the same as that of the first embodiment, but a configuration of an atomizing and regenerating unit is different from that of the first embodiment. Moreover, the fourth embodiment is similar to the third embodiment in that the atomizing and regenerating unit includes three atomizing tanks.

FIG. 4 illustrates a schematic configuration of the air conditioner of the fourth embodiment.

In FIG. 4, constituent elements common to FIGS. 1 and 3 will be given the same reference signs, and detailed description thereof will be omitted.

As illustrated in FIG. 3, an air conditioner 70 includes the moisture absorption unit 11, the first liquid hygroscopic material transport pipe 12, an atomizing and regenerating unit 71, the second liquid hygroscopic material transport pipe 62, a plurality of circulation pipes 721, 722, and 723 (circulation flow paths), a droplet separating unit 73, the reflux pipe 42 (reflux flow path), an atomized droplet collecting unit 74, and the control unit 17. The atomizing and regenerating unit 71 includes a first atomizing tank 711, a second atomizing tank 712, a third atomizing tank 713, the third liquid hygroscopic material transport pipe 614, and the fourth liquid hygroscopic material transport pipe 615, similarly to the atomizing and regenerating unit 61 of the third embodiment.

Differently from the third embodiment, each of the circulation pipes 721, 722, and 723 is provided in a corresponding atomizing tank. That is, a first circulation pipe 721 (first circulation flow path) is connected between a second discharge port 711b and an air supply port 711c of the first atomizing tank 711. Through the first circulation pipe 721, the air containing the atomized droplets T generated in the first atomizing tank 711 is discharged from the first atomizing tank 711, and the air from which at least some of the atomized droplets T are removed is returned to the first atomizing tank 711.

Similarly, a second circulation pipe 722 (second circulation flow path) is connected between a second discharge port 712b and an air supply port 712c of the second atomizing tank 712. Through the second circulation pipe 722, the air containing the atomized droplets T generated in the second atomizing tank 712 is discharged from the second atomizing tank 712, and the air from which at least some of the atomized droplets T are removed is returned to the second atomizing tank 712.

A third circulation pipe 723 is connected between a second discharge port 713b and an air supply port 713c of the third atomizing tank 713. Through the third circulation pipe 723, the air containing the atomized droplets T generated in the third atomizing tank 713 is discharged from the third atomizing tank 713, and the air from which at least some of the atomized droplets T are removed is returned to the third atomizing tank 713. The blower 34 by which the air is circulated is provided in the middle of each of the circulation pipes 721, 722, and 723.

The droplet separating unit 73 is provided so as to be used commonly in the first circulation pipe 721, the second circulation pipe 722, and the third circulation pipe 723. That is, the droplet separating unit 73 is provided in the middle of the first circulation pipe 721, the middle of the second circulation pipe 722, and the middle of the third circulation pipe 723.

The atomized droplet collecting unit 74 is provided so as to be used commonly in the first circulation pipe 721, the second circulation pipe 722, and the third circulation pipe 723, similarly to the droplet separating unit 73. That is, the atomized droplet collecting unit 74 is provided in the middle of the first circulation pipe 721, the middle of the second circulation pipe 722, and the middle of the third circulation pipe 723 on a downstream side of the droplet separating unit 73.

In other words, as illustrated in FIG. 3, the droplet separating unit 41, the atomized droplet collecting unit 16, the first atomizing tank 611, the second atomizing tank 612, and the third atomizing tank 613 communicate via the circulation pipe 63 in series in the third embodiment. On the other hand, as illustrated in FIG. 4, the first atomizing tank 711, the second atomizing tank 712, and the third atomizing tank 713 communicate with the droplet separating unit 73 and the atomized droplet collecting unit 74 via the first circulation pipe 721, the second circulation pipe 722, and the third circulation pipe 723, respectively, in parallel in the present embodiment.

The other points of the configuration of the air conditioner 70 are similar to those of the first embodiment and the third embodiment.

Similarly to the first embodiment, the air conditioner 70 of the present embodiment is also able to provide an effect that the air conditioner capable of reducing power consumption required for regeneration of the liquid hygroscopic material is able to be achieved. Moreover, similarly to the first embodiment, it is possible to provide an effect that a possibility that the environmental load is caused or a possibility that the humidity lowering effect is not sufficiently exerted is able to be eliminated.

In addition, an effect specific to the present embodiment is as follows.

In the present embodiment, each of the first circulation pipe 721, the second circulation pipe 722, and the third circulation pipe 723 is provided in the corresponding atomizing tank, and it is possible to control the flow rate of the air for each atomizing tank by controlling the rotational speed of the blower 34 provided in the corresponding one of the circulation pipes 721, 722, and 723. Thus, for example, by controlling the flow rate of the first circulation pipe 721, which is connected to the first atomizing tank 711 in which the liquid hygroscopic material contains moisture most and the atomized droplets T are most easily generated among the three atomizing tanks 711, 712, and 713, to be the highest, it is possible to enhance atomizing efficiency of the atomizing and regenerating unit 71 as a whole.

### Fifth Embodiment

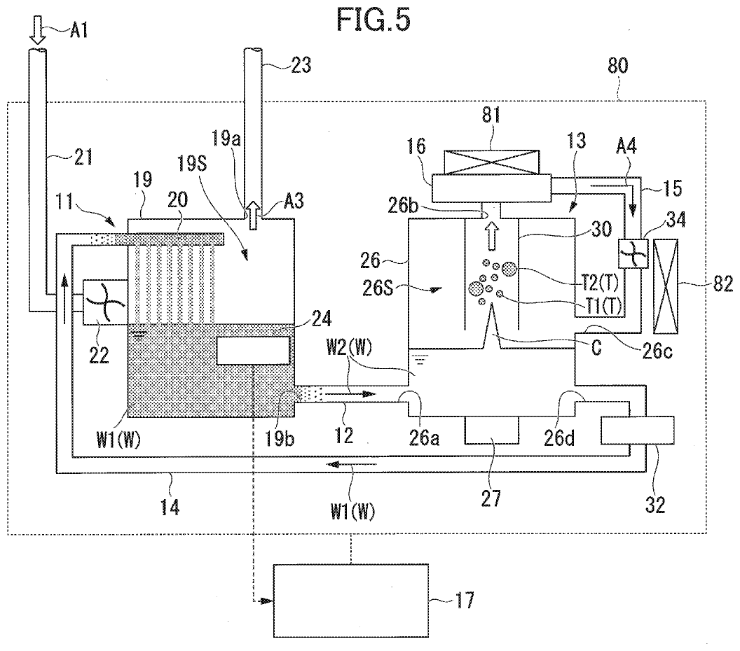

An air conditioner of a fifth embodiment will be described below with reference to FIG. 5.

A basic configuration of the air conditioner of the fifth embodiment is the same as that of the first embodiment, but the air conditioner of the fifth embodiment is different from that of the first embodiment in that a cooling unit and a heating unit are included.

FIG. 5 illustrates a schematic configuration of the air conditioner of the fifth embodiment.

In FIG. 5, constituent elements common to the first embodiment in FIG. 1 will be given the same reference signs, and detailed description thereof will be omitted.

As illustrated in FIG. 5, an air conditioner 80 of the present embodiment includes the moisture absorption unit 11, the first liquid hygroscopic material transport pipe 12, the atomizing and regenerating unit 13, the second liquid hygroscopic material transport pipe 14, the circulation pipe 15 (circulation flow path), the atomized droplet collecting unit 16, a cooling unit 81, a heating unit 82, and the control unit 17. That is, the air conditioner 80 of the present embodiment further includes the cooling unit 81 and the heating unit 82 in addition to the configuration of the air conditioner 10 of the first embodiment.

The cooling unit 81 is provided in the atomized droplet collecting unit 16 in the air conditioner 80 of the present embodiment. The cooling unit 81 cools the air which is supplied to the atomized droplet collecting unit 16 and contains the atomized droplets T. The cooling unit 81 is constituted by, for example, a Peltier element, a heat pump, any air cooling device, or any water cooling device.

The heating unit 82 is provided in the middle of the circulation pipe 15. The heating unit 82 heats the air A4 which flows in the circulation pipe 15 and from which at least some of the atomized droplets T are removed. The heating unit 82 is constituted by, for example, a Peltier element, a heat pump, a resistance heating device, or a lamp heating device.

The other points of the configuration of the air conditioner 80 are the same as those of the first embodiment.

Similarly to the first embodiment, the air conditioner 80 of the present embodiment is also able to provide an effect that the air conditioner capable of reducing power consumption required for regeneration of the liquid hygroscopic material is able to be achieved. Moreover, similarly to the first embodiment, it is possible to provide an effect that a possibility that the environmental load is caused or a possibility that the humidity lowering effect is not sufficiently exerted is able to be eliminated.

In addition, an effect specific to the present embodiment is as follows.

Since the cooling unit 81 is provided in the atomized droplet collecting unit 16 and the air which flows into the atomized droplet collecting unit 16 and contains the atomized droplets T is cooled, moisture contained in the atomized droplets T easily condenses, and it is possible to enhance the speed of collecting the moisture. Moreover, since the heating unit 82 is provided in the middle of the circulation pipe 15 and the air A4 from which at least some of the atomized droplets T are removed is heated, atomization of moisture in the atomizing and regenerating tank 26 is accelerated, and it is possible to enhance the speed of the atomization. With such effects, it is possible to improve the dehumidification speed of the entire air conditioner 80 including the moisture absorption unit 11.

The air conditioner 80 of the present embodiment includes the cooling unit 81 and the heating unit 82, but may include only one of the cooling unit 81 and the heating unit 82. Even when only one of the cooling unit 81 and the heating unit 82 is included, it is possible to improve the dehumidification speed.

Note that a technical scope of the invention is not limited to the aforementioned embodiments and may be variously modified in a range not departing from the gist of the invention.

For example, although an example in which the atomizing and regenerating unit includes the plurality of atomizing tanks is described in the third embodiment and an example in which the air conditioner includes the cooling unit and the heating unit is described in the fifth embodiment, the atomizing and regenerating unit may include the plurality of atomizing tanks and also include the cooling unit and the heating unit. In this manner, configurations specific to different embodiments may be appropriately combined. In addition, the specific configurations related to, for example, a shape, arrangement, or the number of constituent elements of the air conditioner are not limited to those of the aforementioned embodiments and are able to be appropriately modified. For example, although the circulation flow path and the reflux flow path are respectively constituted by the circulation pipe and the reflux pipe in the aforementioned embodiments, a pipe is not necessarily required to be used, and any flow path may be used as long as liquid or the air is able to flow therethrough.

### INDUSTRIAL APPLICABILITY

The invention is able to be utilized for an air conditioner that includes a humidity control function.

1. An air conditioner comprising:
a moisture absorption unit that brings a liquid hygroscopic material, which contains a hygroscopic substance, and air into contact with each other and thereby causes the liquid hygroscopic material to absorb at least some moisture contained in the air;
an atomizing and regenerating unit that atomizes at least some moisture contained in the liquid hygroscopic material supplied from the moisture absorption unit, generates atomized droplets, and removes at least some of the atomized droplets from the liquid hygroscopic material to thereby regenerate the liquid hygroscopic material and supply the regenerated liquid hygroscopic material to the moisture absorption unit;
a circulation flow path through which air containing the atomized droplets generated in the atomizing and regenerating unit is discharged from the atomizing and regenerating unit and the air from which at least some of the atomized droplets are removed is returned to the atomizing and regenerating unit; and
an atomized droplet collecting unit that is provided in the circulation flow path and that collects at least some of the atomized droplets from the air containing the atomized droplets.

2. The air conditioner according to claim 1, further comprising a droplet separating unit that is provided in the circulation flow path and that separates first droplets which are included in the atomized droplets and have a relatively small diameter and second droplets which are included in the atomized droplets and have a relatively large diameter.

3. The air conditioner according to claim 2, further comprising a reflux flow path through which the second droplets separated by the droplet separating unit are returned to the atomizing and regenerating unit.

4. The air conditioner according to claim 3, wherein
the atomizing and regenerating unit includes at least a first atomizing tank connected to the moisture absorption unit and a second atomizing tank connected to the first atomizing tank,
the reflux flow path is a flow path through which the second droplets are returned to the first atomizing tank, and
the circulation flow path is a flow path via which the droplet separating unit, the atomized droplet collecting unit, the first atomizing tank, and the second atomizing tank communicate in series.

5. The air conditioner according to claim 3, wherein
the atomizing and regenerating unit includes at least a first atomizing tank connected to the moisture absorption unit and a second atomizing tank connected to the first atomizing tank,
the reflux flow path is a flow path through which the second droplets are returned to the first atomizing tank, and
the circulation flow path includes at least a first circulation flow path via which the droplet separating unit, the atomized droplet collecting unit, and the first atomizing tank communicate and a second circulation flow path via which the droplet separating unit, the atomized droplet collecting unit, and the second atomizing tank communicate.

6. The air conditioner according to claim 1, further comprising a cooling unit that is provided in the atomized droplet collecting unit and that cools the air which is supplied to the atomized droplet collecting unit and which contains the atomized droplets.

7. The air conditioner according to claim 1, further comprising a heating unit that is provided in the circulation flow path and that heats the air which flows in the circulation flow path and from which at least some of the atomized droplets are removed.
